(19) United States
(12) Patent Application Publication
(10) Pub. No.: US 2007/0119925 A1
(43) Pub. Date: May 31, 2007

(54) Burglarproof tag and method for preventing tag data from being stolen

(76) Inventor: Jung-Bang Wang, Linkou Township (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/349,993

(22) Filed: Feb. 9, 2006

(30) Foreign Application Priority Data
Nov. 29, 2005 (TW) 94141956

(51) Int. Cl. G06K 15/00

(52) U.S. Cl. 235/383

(57) ABSTRACT

A burglarproof tag and a method for preventing tag data from being stolen are disclosed. The burglarproof tag includes a license number (Ln) corresponding to a license code (L code) and a royalty number (Rn) corresponding to a royalty code (R code) by way of a random code. Moreover, both the Ln and the Rn are disposed on a corresponding product. Whereby, after using an audit unit to read a tag with the L code and the R code, a user can directly use the audit unit to judge whether the tag corresponds to the L code and the R code that are stored in the audit unit, for identifying whether the corresponding product has been licensed and for preventing the L code and the R code from being stolen.

### BACKGROUND OF THE INVENTION

1. Field of the Invention

The present invention relates to a burglarproof tag and a method for preventing tag data from being stolen, and particularly relates to a license number (Ln) corresponding to a license code (L code) and a royalty number (Rn) corresponding to a royalty code (R code) by way of a random code. Moreover, both the Ln and the Rn are disposed on a corresponding product for preventing the L code and the R code from being stolen.

2. Description of the Related Art

A product that has been properly licensed needs to meet two conditions, including (1) the corresponding product has been licensed to allow manufacturing, and (2) a licensee has paid royalty fees for the product. However, under the lure of benefit, a lot of illegal manufacturers produce many products that encroach upon the legal rights of a patent holder. Also, some manufacturers that have obtained a license to manufacture a product utilize the license to cover up illegal behavior and evade paying royalty fees to the right holder. These encroachments upon licensed products have made the normal market circulation of commodities suffer greatly, especially licensees that have spent a large amount of manpower and financial resources in creating a fine brand. Moreover, because of the progress and development of science and technology, counterfeiters can often easily produce something that is faked but looks like the genuine article. Hence, a lot of anti-falsification technology is actually useless in identifying whether an article is genuine or not.

In order to solve the problem of products being counterfeited, it is important to improve anti-falsification technology. Many kinds of anti-counterfeit tags have already been disclosed in prior art, such as laser holographs, fluorescent ink, or variable ink, etc. However, the greatest problem of current anti-falsification technology is that if consumers want to distinguish between genuine and fake goods, they must rely on a corresponding equipment or tool to help them make that distinction. As stated, with the development of science and technology, counterfeiters can make anti-counterfeit tags that are faked but look genuine. Therefore, it is difficult to stop imitations and the encroachment upon licensed products.

Moreover, in regard to current anti-counterfeit methods, some people arrange digital data or bar codes on a product via etching or printing methods. Other people arrange digital data behind an anti-counterfeit tag and then attach the anti-counterfeit tag on the product. Hence, anyone can read the anti-counterfeit tag that is arranged on the product or the packaging of the product, either by simply looking at it, or by using a reader, to identify whether the product is genuine or fake and whether the product manufacturer has obtained a license or not. However, the above-mentioned current anti-counterfeit methods can only distinguish whether the product in question is licensed or not. They are unable to calculate the total number of products that have been manufactured and sold, or calculate the total royalties that the licensee needs to pay to the right holder. Furthermore, they are unable to provide information to a patent holder regarding how much money is owed to the right holder. Moreover, there are some shortcomings in the prior art, such as it is usually difficult for people other than the right holder or a licensee to distinguish between genuine or fake products simply by examining an anti-counterfeit tag, and the anti-counterfeit tag themselves are expensive to manufacture and purchase.

Although, through the above described methods, there are ways to stymie counterfeiters by using digital data or a tag, there is no any way to prevent the digital data or tag data of the tag from be stolen. Hence, when the digital data or the tag data of the tag is stolen, it inevitably leads great financial losses.

### SUMMARY OF THE INVENTION

The present invention provides a burglarproof tag and a method for preventing tag data from being stolen. The burglarproof tag includes a license number (Ln) corresponding to a license code (L code) and a royalty number (Rn) corresponding to a royalty code (R code) by way of a random code. Moreover, both the Ln and the Rn are disposed on a corresponding product for preventing the L code and the R code from being stolen.

A first aspect of the present invention is a burglarproof tag for preventing tag data from being stolen. The burglarproof tag comprises a license number (Ln), a royalty number (Rn) and a tag. The royalty number (Rn) corresponds to the license number (Ln), and the tag is composed of a license code (L code) corresponding to the license number (Ln) and a royalty code (R code) corresponding to the royalty number (Rn), wherein the tag is arranged on a corresponding product, and the L code and the R code are stored in an audit unit. Whereby, after using the audit unit to read the tag that is arranged on the corresponding product, a user can use the audit unit to judge whether the tag corresponds to the L code and the R code that are stored in the audit unit, for identifying whether the corresponding product has been licensed.

Moreover, the Ln and the Rn are arranged on the corresponding product and are stored in the audit unit, whereby, after keying-in the Ln and the Rn in the audit unit, the user can use the audit unit to judge whether the keyed-in Ln and Rn correspond to the Ln and the Rn that are stored in the audit unit for identifying whether the corresponding product has been licensed.

Furthermore, the burglarproof tag further comprises a corresponding code arranged near the tag for displaying a predetermined code that is part of a digitized L code or R code. Hence, after keying-in the corresponding code in the audit unit, the user can use the audit unit to judge whether the tag corresponds to the L code and the R code that are stored in the audit unit for identifying whether the corresponding product has been licensed.

A second aspect of the present invention is a burglarproof tag for preventing tag data from being stolen. The burglarproof tag comprises a license number (Ln), a royalty number (Rn) and a tag. The royalty number corresponds to (Rn) corresponds to the license number (Ln), and the tag is composed of a license code (L code) corresponding to the license number (Ln) and a royalty code (R code) corresponding to the royalty number (Rn), wherein the tag is arranged on a corresponding product, and the L code and the R code are stored in an database. Whereby, a user can use the audit unit to read the tag and to connect with the database via Internet to judge whether the tag corresponds to the L code and the R code that are stored in the database, so as to identify whether the corresponding product has been licensed.

Moreover, the Ln and the Rn are arranged on the corresponding product and are stored in the database, whereby the user keys-in the Ln and the Rn in the audit unit and uses the audit unit to connect with the database via Internet, for judging whether the keyed-in Ln and Rn correspond to the Ln and the Rn that are stored in the database, so as to identify whether the corresponding product has been licensed.

Furthermore, the burglarproof tag further comprises a corresponding code arranged near the tag for displaying a predetermined code that is a part of digitized L code or R code. Hence, the user can key-in the corresponding code in the audit unit and use the audit unit to connect with the database via Internet, for judging whether the corresponding code corresponds to the L code and the R code that are stored in the database, so as to identify whether the corresponding product has been licensed.

A third aspect of the present invention is a method for preventing tag data from being stolen. The method comprises: firstly, providing a plurality of license numbers (Lns) and royalty numbers (Rns), wherein each Ln corresponds to a license code (L code) and each Rn corresponds to a royalty code (R code); randomly mating Ln and Rn to produce a plurality of corresponding Ln+Rn sets; next, combining the L code that corresponds to the Ln with the R code that corresponds to the Rn to form a tag with a single legal authorization code (L code+R code) from each corresponding Ln+Rn set; and then arranging each tag and each Ln+Rn set that corresponds to the tag on a corresponding product; finally, identifying whether the corresponding product with the tag and the Ln+Rn has been licensed.

Moreover, the method further comprises storing the L code and the R code in an audit unit, whereby after using the audit unit to read the tag that is arranged on the corresponding product, a user can use the audit unit to judge whether the tag corresponds to the L code and the R code that are stored in the audit unit, for identifying whether the corresponding product has been licensed. In addition, the method further comprises storing the Ln and the Rn in an audit unit, whereby after keying-in the Ln and the Rn in the audit unit, the user can use the audit unit to judge whether the keyed-in Ln and Rn correspond to the Ln and the Rn that are stored in the audit unit for identifying whether the corresponding product has been licensed.

Furthermore, the method further comprises storing the L cord and the R code in a database, whereby, a user can use the audit unit to read the tag and to connect with the database via Internet to judge whether the tag corresponds to the L code and the R code that are stored in the database, so as to identify whether the corresponding product has been licensed. In addition, the method further comprises storing the Ln and the Rn in a database, whereby, the user keys-in the Ln and the Rn in the audit unit and uses the audit unit to connect with the database via Internet, for judging whether the keyed-in Ln and Rn correspond to the Ln and the Rn that are stored in the database, so as to identify whether the corresponding product has been licensed.

It is to be understood that both the foregoing general description and the following detailed description are exemplary, and are intended to provide further explanation of the invention as claimed. Other advantages and features of the invention will be apparent from the following description, drawings and claims.

### BRIEF DESCRIPTION OF THE DRAWINGS

The various objects and advantages of the present invention will be more readily understood from the following detailed description when read in conjunction with the appended drawings, in which:

FIG. 1 is a function block diagram of a burglarproof tag for preventing tag data from being stolen according to the first embodiment of the present invention;

FIG. 2 is a function block diagram of a burglarproof tag for preventing tag data from being stolen according to the second embodiment of the present invention;

FIG. 3 is a flowchart of a method for preventing tag data from being stolen according to the first embodiment of the present invention; and

FIG. 4 is a flowchart of a method for preventing tag data from being stolen according to the second embodiment of the present invention.

### DETAILED DESCRIPTION OF PREFERRED BEST MOLDS

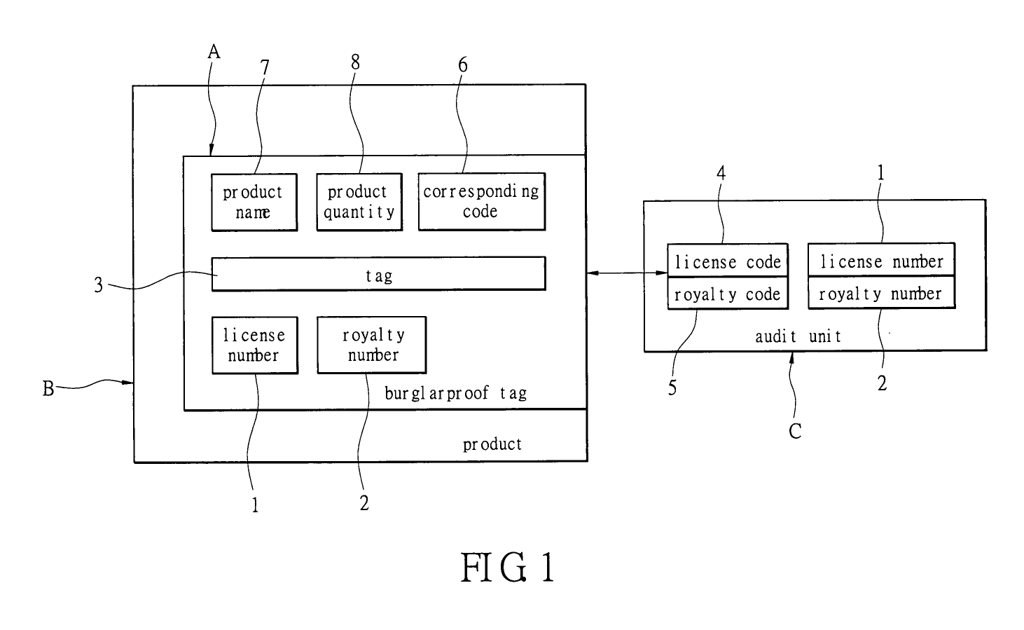

FIG. 1 shows a function block diagram of a burglarproof tag for preventing tag data from being stolen according to a first embodiment of the present invention. The present invention provides a burglarproof tag A for preventing tag data from being stolen. The burglarproof tag A includes a license number (Ln) 1, a royalty number (Rn) 2 and a tag 3. The tag 3 can be an RFID tag or a bar code according to a user's need.

Moreover, the Rn 2 corresponds to the Ln 1. The tag 3 is composed of a license code (L code) 4 and a royalty code (R code) 5, and the L code 4 corresponds to the Ln 1 and the R code 5 corresponds to the Rn 2. In addition, the Ln 1, the Rn 2 and the tag 3 are all arranged on a corresponding product B, and the Ln 1, the Rn 2, the L code 4 and the R code 5 are all stored in an audit unit C. In addition, the audit unit C can be a portable computer, a portable reader, or a PDA.

Furthermore, the L code 4 and the R code 5 are combined together to form a single legal authorization code (L code+R code), and the single legal authorization code (L code+R code) is arranged on the corresponding product B according to different products of a right holder and different licensees.

Hence, after using the audit unit C to read the tag 3 that is arranged on the corresponding product B, a user can use the audit C to judge whether the tag 3 corresponds to the L code 4 and the R code 5 that are stored in the audit unit C, for identifying whether the corresponding product B has been licensed. In addition, the Ln 1 and the Rn 2 are arranged on the corresponding product B and are stored in the audit unit C. Whereby, after keying-in the Ln 1 and the Rn 2 in the audit unit C, the user can use the audit C to judge whether the keyed-in Ln and Rn correspond to the Ln and the Rn that are stored in the audit unit for identifying whether the corresponding product B has been licensed.

Furthermore, the burglarproof tag A further includes a corresponding code 6 arranged near the tag 3 for displaying a predetermined code that is a part of digitized L code or R code. In the best mold, the corresponding code 6 can be last four digits of the digitized L code or R code.

Hence, after keying-in the corresponding code 6 in the audit unit C, the user can use the audit unit C to judge whether the tag 3 corresponds to the L code 4 and the R code 5 that are stored in the audit unit C for identifying whether the corresponding product B has been licensed. For example, when the corresponding code 6 is “abcd” shown on the corresponding product B, and the user uses the audit unit C to read the tag 3 and the audit unit C shows that the last four digits of the tag 3 are “abcd”, it means that the corresponding product B has been licensed.

In addition, the burglarproof tag A further includes a product name 7 and a product quantity 8 arranged near the tag.

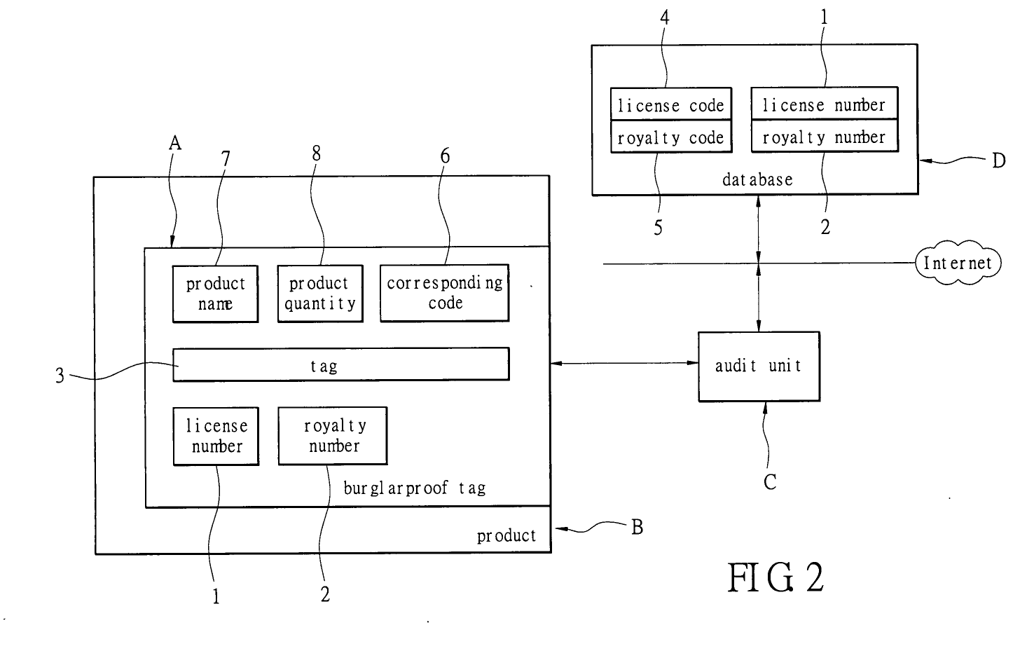

FIG. 2 shows a function block diagram of a burglarproof tag for preventing tag data from being stolen according to the second embodiment of the present invention. The difference between the first embodiment and the second embodiment is that in the second embodiment the Ln 2, the Rn 3, the L code 4 and the R code 5 are all stored in a database D.

Hence, the user can use the audit unit C to read the tag 3 and to connect with the database D via Internet to judge whether the tag 3 corresponds to the L code 4 and the R code 5 that are stored in the database D, so as to identify whether the corresponding product B has been licensed. In addition, the Ln 1 and the Rn 2 are arranged on the corresponding product B and are stored in the database D. Whereby, the user can key-in the Ln 1 and the Rn 2 in the audit unit C and use the audit unit C to connect with the database D via Internet, for judging whether the keyed-in Ln and Rn correspond to the Ln 1 and the Rn 2 that are stored in the database D, so as to identify whether the corresponding product has been licensed.

Moreover, the burglarproof tag A further includes a corresponding code 6 arranged near the tag 3 for displaying a predetermined code that is a part of digitized L code or R code. Hence, the user can key-in the corresponding code 6 in the audit unit C and uses the audit unit C to connect with the database D via Internet, for judging whether the corresponding code 6 corresponds to the L code 4 and the R code 5 that are stored in the database D, so as to identify whether the corresponding product B has been licensed.

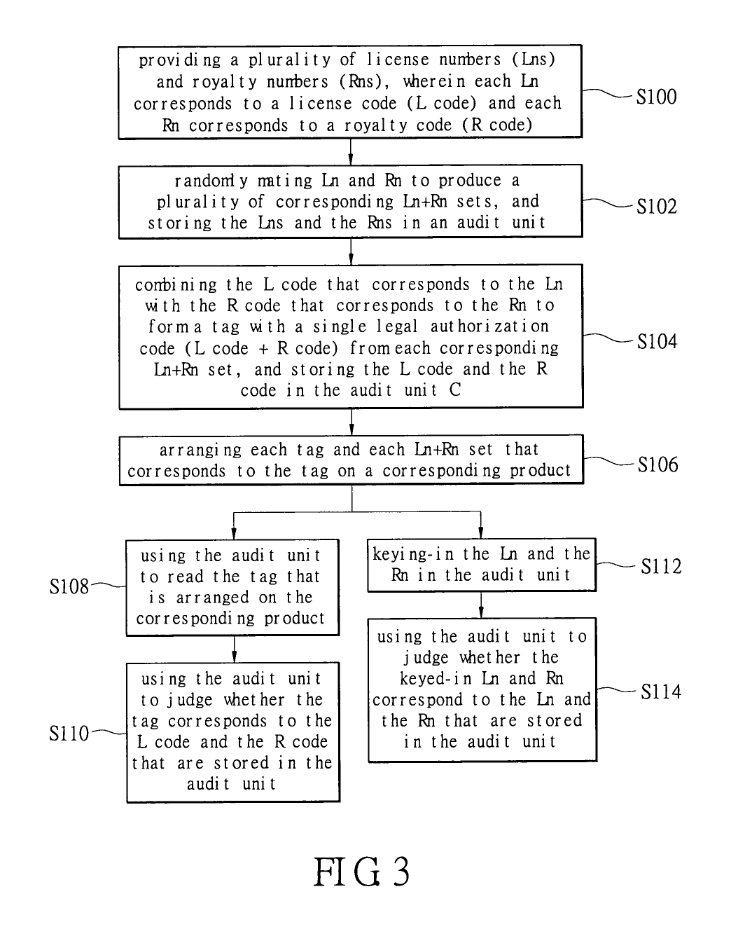

FIG. 3 shows a flowchart of a method for preventing tag data from being stolen according to the first embodiment of the present invention. The method includes: firstly, providing a plurality of license numbers (Lns) 1 and royalty numbers (Rns) 2, wherein each Ln 1 corresponds to a license code (L code) 4 and each Rn 2 corresponds to a royalty code (R code) 5 (S100); next, randomly mating Ln 1 and Rn 2 to produce a plurality of corresponding Ln+Rn sets, and storing the Lns 1 and the Rns 2 in an audit unit C (S102).

Moreover, the method further includes: combining the L code 4 that corresponds to the Ln 1 with the R code 5 that corresponds to the Rn 2 to form a tag 3 with a single legal authorization code (L code+R code) from each corresponding Ln+Rn set, and storing the L code 4 and the R code 5 in the audit unit C (S104); next, arranging each tag 3 and each Ln+Rn set that corresponds to the tag 3 on a corresponding product B (S106).

After the step of S106, the method further includes: using the audit unit C to read the tag 3 that is arranged on the corresponding product B (S108), and then using the audit unit C to judge whether the tag 3 corresponds to the L code 4 and the R code 5 that are stored in the audit unit C (S110), for identifying whether the corresponding product has been licensed.

After the step of S106, the method further includes: keying-in the Ln 1 and the Rn 2 in the audit unit C (S112), and then using the audit unit C to judge whether the keyed-in Ln and Rn correspond to the Ln 1 and the Rn 2 that are stored in the audit unit C (S114), for identifying whether the corresponding product has been licensed.

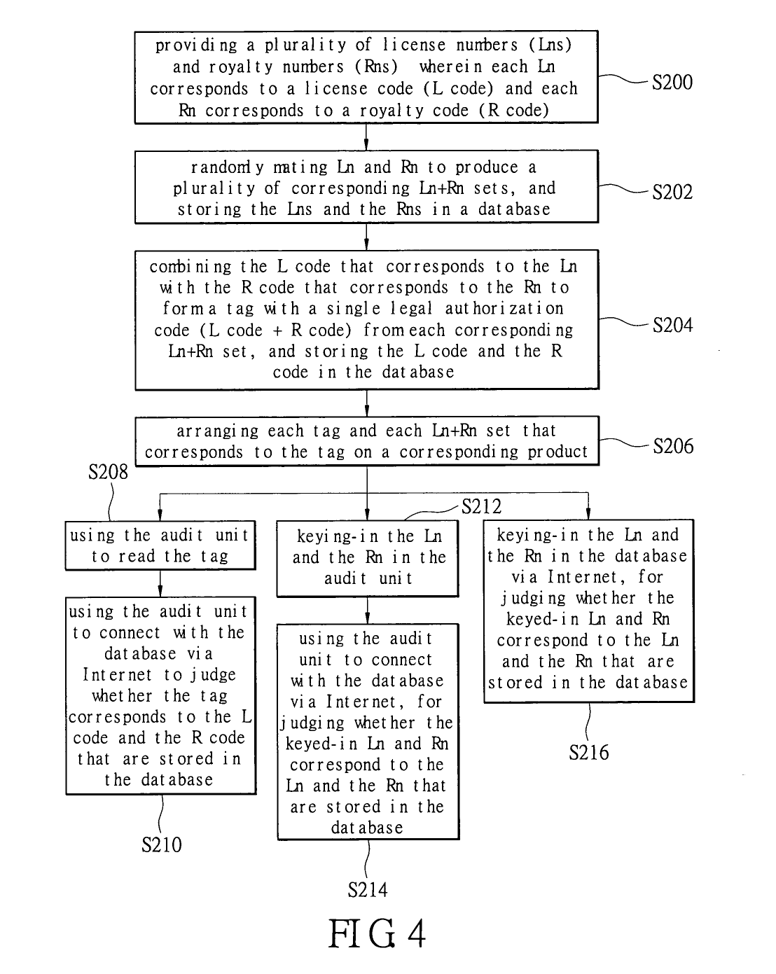

FIG. 4 shows a flowchart of a method for preventing tag data from being stolen according to the second embodiment of the present invention. The method includes: firstly, providing a plurality of license numbers (Lns) 1 and royalty numbers (Rns) 2, wherein each Ln 1 corresponds to a license code (L code) 4 and each Rn 2 corresponds to a royalty code (R code) 5 (S200); next, randomly mating Ln 1 and Rn 2 to produce a plurality of corresponding Ln+Rn sets, and storing the Lns 1 and the Rns 2 in a database D (S202).

Moreover, the method includes: combining the L code 4 that corresponds to the Ln 1 with the R code 5 that corresponds to the Rn 2 to form a tag 3 with a single legal authorization code (L code+R code) from each corresponding Ln+Rn set, and storing the L code 4 and the R code 5 in the database D (S204); next, arranging each tag 3 and each Ln+Rn set that corresponds to the tag 3 on a corresponding product B (S206).

After the step of S206, the method further includes: using the audit unit C to read the tag 3 (S208), and using the audit unit C to connect with the database D via Internet to judge whether the tag 3 corresponds to the L code 4 and the R code 5 that are stored in the database D (S210), so as to identify whether the corresponding product has been licensed.

After the step of S206, the method further includes: keying-in the Ln 1 and the Rn 2 in the audit unit C (S212), and using the audit unit C to connect with the database D via Internet, for judging whether the keyed-in Ln and Rn correspond to the Ln 1 and the Rn 2 that are stored in the database D (S214), so as to identify whether the corresponding product has been licensed.

After the step of S206, the method further includes: keying-in the Ln 1 and the Rn 2 in the database D via Internet, for judging whether the keyed-in Ln and Rn correspond to the Ln 1 and the Rn 2 that are stored in the database D (S216), so as to identify whether the corresponding product has been licensed.

Although the present invention has been described with reference to the preferred best molds thereof, it will be understood that the invention is not limited to the details thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A burglarproof tag for preventing tag data from being stolen, comprising:
a license number (Ln);
a royalty number (Rn) corresponding to the license number (Ln); and
a tag composed of a license code (L code) corresponding to the license number (Ln) and a royalty code (R code) corresponding to the royalty number (Rn), wherein the tag is arranged on a corresponding product, and the L code and the R code are stored in an audit unit;
whereby, after using the audit unit to read the tag that is arranged on the corresponding product, a user uses the audit unit to judge whether the tag corresponds to the L code and the R code that are stored in the audit unit, for identifying whether the corresponding product has been licensed.

2. The burglarproof tag as claimed in claim 1, wherein the L code and the R code are combined together to form a single legal authorization code (L code+R code).

3. The burglarproof tag as claimed in claim 2, wherein the single legal authorization code (L code+R code) is arranged on the corresponding product according to different products of a right holder and different licensees.

4. The burglarproof tag as claimed in claim 1, further comprising a corresponding code arranged near the tag for displaying a predetermined code that is a part of digitized L code or R code.

5. The burglarproof tag as claimed in claim 4, wherein after keying-in the corresponding code in the audit unit, the user uses the audit unit to judge whether the tag corresponds to the L code and the R code that are stored in the audit unit for identifying whether the corresponding product has been licensed.

6. The burglarproof tag as claimed in claim 1, wherein the Ln and the Rn are arranged on the corresponding product and are stored in the audit unit, whereby after keying-in the Ln and the Rn in the audit unit, the user uses the audit unit to judge whether the keyed-in Ln and Rn correspond to the Ln and the Rn that are stored in the audit unit for identifying whether the corresponding product has been licensed.

7. The burglarproof tag as claimed in claim 1, further comprising a product name and a product quantity arranged near the tag.

8. The burglarproof tag as claimed in claim 1, wherein the tag is an RFID tag or a bar code.

9. The burglarproof tag as claimed in claim 1, wherein the audit unit is a portable computer, a portable reader or a PDA.

10. A burglarproof tag for preventing tag data from being stolen, comprising:
a license number (Ln);
a royalty number (Rn) corresponding to the license number (Ln); and
a tag composed of a license code (L code) corresponding to the license number (Ln) and a royalty code (R code) corresponding to the royalty number (Rn), wherein the tag is arranged on a corresponding product, and the L code and the R code are stored in an database;
whereby, a user uses the audit unit to read the tag and to connect with the database via Internet to judge whether the tag corresponds to the L code and the R code that are stored in the database, so as to identify whether the corresponding product has been licensed.

11. The burglarproof tag as claimed in claim 10, wherein the L code and the R code are combined together to form a single legal authorization code (L code+R code).

12. The burglarproof tag as claimed in claim 11, wherein the single legal authorization code (L code+R code) is arranged on the corresponding product according to different products of a right holder and different licensees.

13. The burglarproof tag as claimed in claim 10, further comprising a corresponding code arranged near the tag for displaying a predetermined code that is a part of digitized L code or R code.

14. The burglarproof tag as claimed in claim 13, wherein the user keys-in the corresponding code in the audit unit and uses the audit unit to connect with the database via Internet, for judging whether the corresponding code corresponds to the L code and the R code that are stored in the database, so as to identify whether the corresponding product has been licensed.

15. The burglarproof tag as claimed in claim 10, wherein the Ln and the Rn are arranged on the corresponding product and are stored in the database, whereby the user keys-in the Ln and the Rn in the audit unit and uses the audit unit to connect with the database via Internet, for judging whether the keyed-in Ln and Rn correspond to the Ln and the Rn that are stored in the database, so as to identify whether the corresponding product has been licensed.

16. The burglarproof tag as claimed in claim 10, further comprising a product name and a product quantity arranged near the tag.

17. The burglarproof tag as claimed in claim 10, wherein the tag is an RFID tag or a bar code.

18. The burglarproof tag as claimed in claim 10, wherein the audit unit is a portable computer, a portable reader or a PDA.

19. A method for preventing tag data from being stolen, comprising:
providing a plurality of license numbers (Lns) and royalty numbers (Rns), wherein each Ln corresponds to a license code (L code) and each Rn corresponds to a royalty code (R code);
randomly mating Ln and Rn to produce a plurality of corresponding Ln+Rn sets;
combining the L code that corresponds to the Ln with the R code that corresponds to the Rn to form a tag with a single legal authorization code (L code+R code) from each corresponding Ln+Rn set;
arranging each tag and each Ln+Rn set that corresponds to the tag on a corresponding product; and
identifying whether the corresponding product with the tag and the Ln+Rn have been licensed.

20. The method as claimed in claim 19, further comprising storing the L code and the R code in an audit unit, whereby after using the audit unit to read the tag that is arranged on the corresponding product, a user uses the audit unit to judge whether the tag corresponds to the L code and the R code that are stored in the audit unit, for identifying whether the corresponding product has been licensed.

21. The method as claimed in claim 19, further comprising storing the Ln and the Rn in an audit unit, whereby after keying-in the Ln and the Rn in the audit unit, the user uses the audit unit to judge whether the keyed-in Ln and Rn correspond to the Ln and the Rn that are stored in the audit unit for identifying whether the corresponding product has been licensed.

22. The method as claimed in claim 19, further comprising storing the L cord and the R code in a database, whereby a user uses the audit unit to read the tag and to connect with the database via Internet to judge whether the tag corresponds to the L code and the R code that are stored in the database, so as to identify whether the corresponding product has been licensed.

23. The method as claimed in claim 19, further comprising storing the Ln and the Rn in a database, whereby the user keys-in the Ln and the Rn in the audit unit and uses the audit unit to connect with the database via Internet, for judging whether the keyed-in Ln and Rn correspond to the Ln and the Rn that are stored in the database, so as to identify whether the corresponding product has been licensed.

24. The method as claimed in claim 19, further comprising a corresponding code arranged near the tag for displaying a predetermined code that is a part of digitized L code or R code.

25. The method as claimed in claim 24, wherein after keying-in the corresponding code in an audit unit, the user uses the audit unit to judge whether the tag corresponds to the L code and the R code that are stored in the audit unit for identifying whether the corresponding product has been licensed.

26. The method as claimed in claim 24, wherein the user keys-in the corresponding code in a database and uses the audit unit to connect with a database via Internet, for judging whether the corresponding code corresponds to the L code and the R code that are stored in the database, so as to identify whether the corresponding product has been licensed.

27. The method as claimed in claim 19, wherein the single legal authorization code (L code+R code) is arranged on the corresponding product according to different products of a right holder and different licensees.

28. The method as claimed in claim 19, further comprising a product name and a product quantity arranged near the tag.

29. The method as claimed in claim 19, wherein the tag is an RFID tag or a bar code.

30. The method as claimed in claim 26, wherein the audit unit is a portable computer, a portable reader or a PDA.
